(19) United States
(12) Patent Application Publication
(10) Pub. No.: US 2007/0141484 A1
(43) Pub. Date: Jun. 21, 2007

(54) COLOR FILTER AND MANUFACTURE METHOD THEREOF

(76) Inventor: Ming-Shu Lee, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/306,158

(22) Filed: Dec. 19, 2005

(51) Int. Cl. G02B 5/20

(52) U.S. Cl. 430/7

(57) ABSTRACT

A color filter including a substrate, a black matrix and a plurality of colored patterns is provided. The black matrix is disposed on the substrate and defines a plurality of sub-pixels on the substrate. In each sub-pixel, the height of the black matrix gradually decreases from the outside to the inside of the sub-pixel. The colored patterns are respectively disposed in the sub-pixels. Besides, a manufacturing method for the color filter mentioned above is also provided.

### BACKGROUND OF THE INVENTION

1. Field of Invention

The present invention relates to a color filter and manufacturing method thereof. More particularly, the present invention relates to a color filter with a planarer surface and a manufacturing method thereof.

2. Description of Related Art

Along with the development of the modern video technology, the liquid crystal display (LCD) has been extensively used as display screens in consumer electronic products such as cellphones, notebooks, personal computers and personal digital assistants (PDA). The liquid crystal panel of LCD mainly consists of an array substrate, a liquid layer and a color filter, wherein the array substrate and color filter are grouped while the liquid layer lies between the array substrate and color filter. The above color filter is fabricated, for example, by first forming a black matrix, a colored pattern, then film layers such as an electrode layer or a protection layer, etc.

The metals with high shading effect, such as chrome and lead, are usually selected as the material of the black matrix. However, along with the rising awareness of environmental protection, the use such metals is forbidden. Instead, the black resin is used, but its shading efficiency is inferior to metals. Therefore, the thickness of the black resin film needs be increased for improving the shading efficiency.

FIG. 1A is a schematic drawing of parts of a conventional color filter. Referring to FIG. 1A, the conventional color filter 100 includes a transparent substrate 110, a black matrix 120 and a plurality of colored patterns 130. The black matrix 120 is disposed on the substrate 110 and defines a plurality of sub-pixels 122 on the substrate 110. A plurality of colored patterns 130 further include a plurality of red colored patterns 132, green colored patterns 134 and blue colored patterns 136, which are respectively disposed in the corresponding sub-pixels 122. Generally, the peripheries of these colored patterns 130 are overlapped with parts of the black matrix 120 so as to reduce color mixing.

FIG. 1B is a cross-sectional view along A-A′ in FIG. 1A. Referring FIG. 1B, since the material of the black matrix 120 is black resin with inferior shading efficiency, a thicker black matrix 120 is needed for desired shading effect. However, the thicker black matrix 120 makes the film thickness of the colored patterns 130 uneven and consequently affects the roughness of the color filter 100. Particularly, the uneven film thickness mainly takes place where the colored patterns 130 and the black matrix 120 are overlapped. That is, because the film of the black matrix 120 is too thick, the colored patterns 130 in the overlapping area would rise above other areas by about d when formed.

Next, when the color filter 100 and the array substrate (not illustrated) are combined in the subsequent process, because the surface of the color filter 100 is too rough, bad alignment of the liquid crystal layer (not illustrated) easily occurs. Besides, if the color filter 100 and the array substrate are assembled with the one drop filling method, ODF, the liquid crystal drops could easily leave traces due to the uneven surface of the color filter 100. Note that in the conventional technology, there are two ways to even the surface of the color filter 100: by reducing the film thickness of the black matrix 120 or reducing the overlapping area of the colored patterns 130 and the black matrix 120. However, reducing the film thickness of the black matrix 120 will result in decreased shading efficiency of the black matrix 120 and increased light leakage; reducing the overlapping area of the colored patterns 130 and the black matrix 120 will increase color mixing. So, a better solution is still desired.

### SUMMARY OF THE INVENTION

Accordingly, the present invention is directed to provide a color filter with a planar surface.

The present invention is also directed to provide a manufacturing method for a color filter with a planar surface.

For achieving the above or other objectives, the present invention provides a color filter, including a substrate, a black matrix and a plurality of colored patterns. The black matrix is disposed on the substrate and defines a plurality of sub-pixels. In each sub-pixel, the height of the black matrix gradually decreases from the periphery of the sub-pixel to the inside of the sub-pixel. A plurality of colored patterns are disposed in the sub-pixels.

According to an embodiment of the present invention, the substrate can be a transparent substrate.

According to an embodiment of the present invention, the material of the black matrix can be black resin.

According to an embodiment of the present invention, the colored patterns can consist of a plurality of red colored patterns, a plurality of green colored patterns and a plurality of blue colored patterns.

According to an embodiment of the present invention, the color filter can further include an electrode layer overlaying the black matrix and the colored pattern. The material of the electrode layer can be indium tin oxide (ITO) or indium zinc oxide (IZO).

Besides, for achieving the above or other objectives, the present invention provides a manufacturing method for the color filter. The method includes the following steps: providing a substrate; forming a photosensitive layer on the substrate; disposing a gray mask above the substrate to perform a exposure process to the photosensitive layer, wherein the gray mask has a transparent area, a nontransparent area and a semitransparent area; performing a development process to pattern the photosensitive layer so as to form a black matrix which defines a plurality of sub-pixels on the substrate, wherein in each sub-pixel, the height of the black matrix gradually decreases from the periphery of the sub-pixel to the inside of the sub-pixel; and forming a plurality of colored patterns in the sub-pixels.

According to an embodiment of the present invention, the substrate can be a transparent substrate.

According to an embodiment of the present invention, the material of the black matrix can be black resin.

According to an embodiment of the present invention, the colored patterns can consist of a plurality of red colored patterns, a plurality of green colored patterns and a plurality of blue colored patterns.

According to an embodiment of the present invention, the colored patterns can further include an electrode layer overlaying the black matrix and the colored pattern. Wherein, the material of the electrode layer can be indium tin oxide or indium zinc oxide.

According to an embodiment of the present invention, the gray mask can be a halftone mask.

According to an embodiment of the present invention, the gray mask can include a plurality of clear meshes which are in the semitransparent area.

According to an embodiment of the present invention, the colored patterns can be fabricated in a pigment dispersing method, a printing method or a color inkjet method.

In summary, in the color filter of the present invention, the height of the black matrix gradually decreases from the periphery of the sub-pixel to the inside of the sub-pixel and the height difference between layers is smaller than that between the black matrix and the substrate in the conventional technology, so that planar colored patterns can be formed in a next step. Accordingly, the color filter of the present invention has a planar surface which helps the subsequent assembly process. Besides, in the present invention, instead of the general mask, the gray mask is used to form the height characteristic that the black matrix gradually decreases, so that an additional mask is not needed.

In order to make the aforementioned and other objects, features and advantages of the present invention comprehensible, a preferred embodiment accompanied with figures is described in detail below.

### BRIEF DESCRIPTION OF THE DRAWINGS

FIG. 1A is a schematic drawing showing parts of a conventional color filter.

FIG. 1B is a cross-sectional view along A-A′ in FIG. 1A.

FIG. 2A is a schematic drawing showing parts of a color filter according to an embodiment of the present invention.

FIG. 2B is a cross-sectional view along A-A′ in FIG. 2A.

FIG. 3A to FIG. 3D are cross-sectional views showing the process of forming the color filter of the present invention.

FIG. 4 is a schematic drawing showing parts of the gray mask according to an embodiment of the present invention.

### DESCRIPTION OF EMBODIMENTS

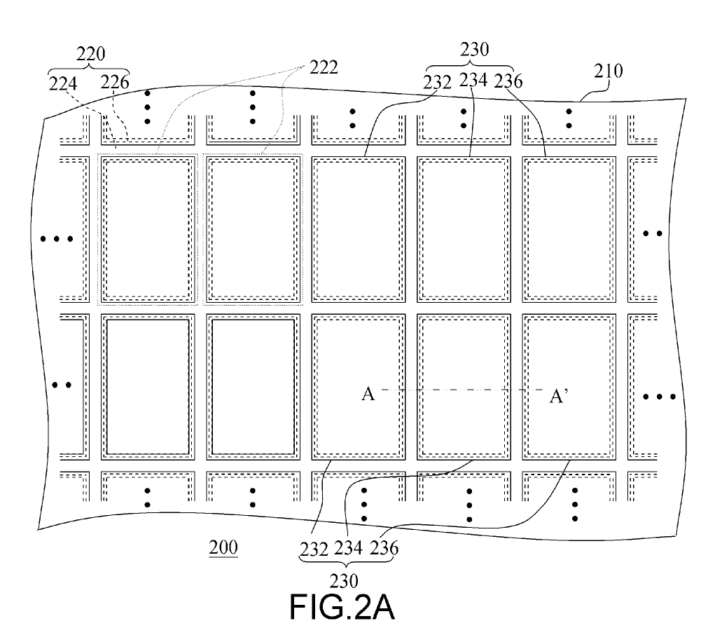

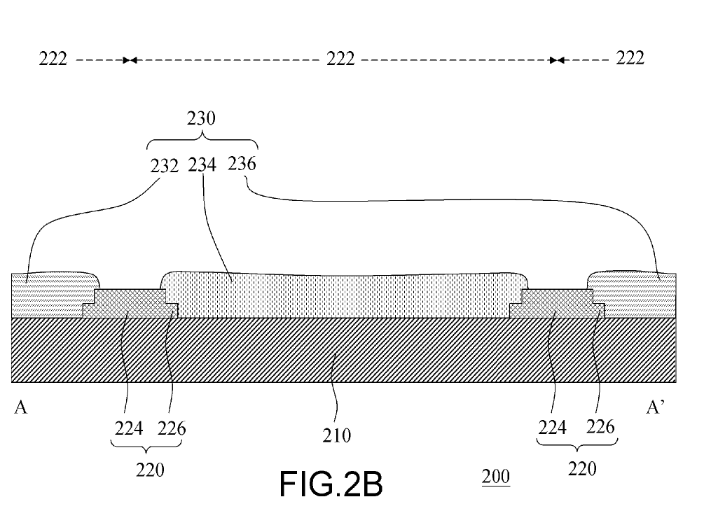

FIG. 2A is a schematic drawing showing parts of a color filter according to an embodiment of the present invention and FIG. 2B is a cross-sectional view along A-A′ in FIG. 2A. Referring to FIG. 2A and FIG. 2B, the color filter 200 of the present invention includes a substrate 210, a black matrix 220 and a plurality of colored patterns 230. The black matrix 220 is disposed on the substrate 210 and defines a plurality of sub-pixels 222 on the substrate 210. When the color filter and an array substrate (not illustrated) are combined, there is a one-to-one correspondence between the sub-pixels 222 and the sub-pixels of the matrix substrate (not illustrated). Besides, the black matrix 220 is mainly used to shade light; that is, to block mixed light from the corresponding areas such as the metal wires of the array substrate, the thin film transistor and so on.

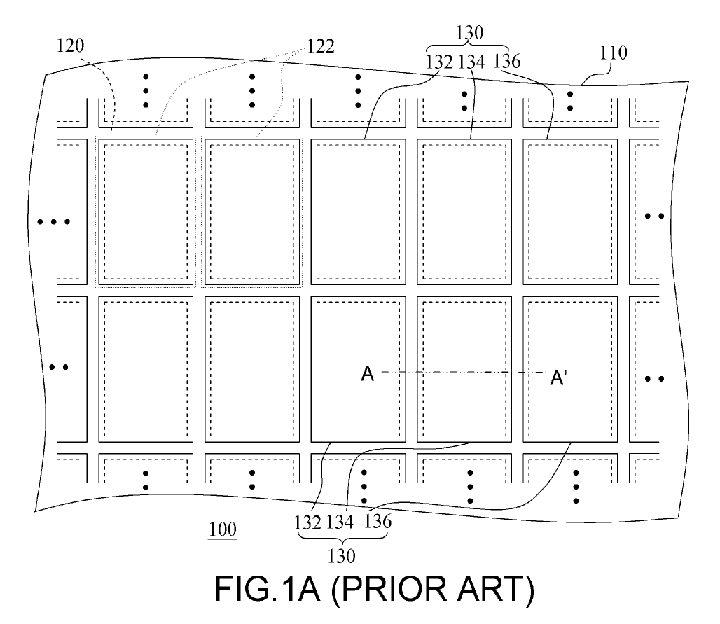

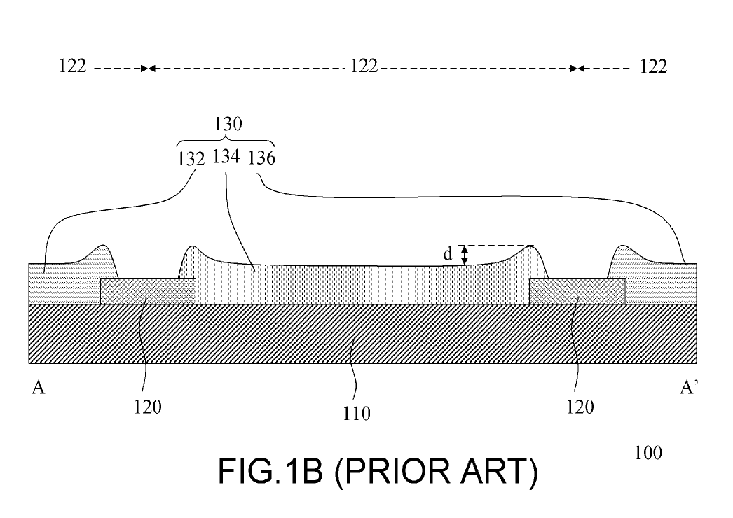

Next, in each sub-pixel 222, the height of the black matrix 220 gradually decreases from the periphery of the sub-pixel 222 to the inside of the sub-pixel 222; that is, the height of the inner area 224 of the black matrix 220 is more than the height of the edge area 226 of the black matrix 220. Besides, the colored pattern 230 is disposed in the sub-pixel 222 and the periphery of the colored pattern 230 overlaps with parts of the black matrix 220. Because the height of the overlapping parts of the black matrix gradually decreases, the height difference between layers is smaller than that of only one layer of the conventional black matrix 120 as shown in FIG. 1B, so that the planar colored pattern 230 can be formed in the next step, which helps the subsequent assembly process.

Note that the overall height of the black matrix 220 is not reduced in the present invention, so the black matrix 220 still maintains the shading effect. Besides, in the present invention, for getting a planar colored pattern 230, it is not necessary to reduce the overlapping area in the colored pattern 230 and the black matrix 220, so that color mixing can be decreased.

Referring to FIG. 2B again, in the present embodiment, the black matrix 220 for example has two heights, gradually decreasing in two steps. However, how the height of the black matrix 220 gradually decreases is not limited in the present invention. For example, the black matrix 220 has n levels of heights and gradually decreases in n steps. Of course, when n is of a high value, the height of the black matrix 220 will planarly decrease like a hillside. Besides, the substrate 210 can be a transparent substrate, a transparent glass substrate or a transparent flexible substrate.

Next, in the present embodiment, a plurality of colored patterns 230 include a plurality of red patterns 232, a plurality of green patterns 234 and a plurality of blue patterns 236, which are respectively disposed in the corresponding sub-pixels 222. When light goes through the red colored pattern 232, the green colored pattern 234 and the blue colored pattern 236, it is respectively filtered into red, green and blue light, whose intensity is adjusted according with the array substrate to form images. Note that the colored pattern 230 of the present invention is not limited to the three colors of colored patterns. For the desired effect, different colored patterns can be used according to the requirement.

In addition, the color filter 200 of the present invention can further include an electrode layer (not illustrated) or a protection layer (not illustrated), which overlays the black matrix 220 and the colored pattern 230, wherein, the material of the electrode layer can be indium tin oxide (ITO). In the following, the manufacturing method for the color filter 200 of the present invention is described in detail with the accompanying drawings.

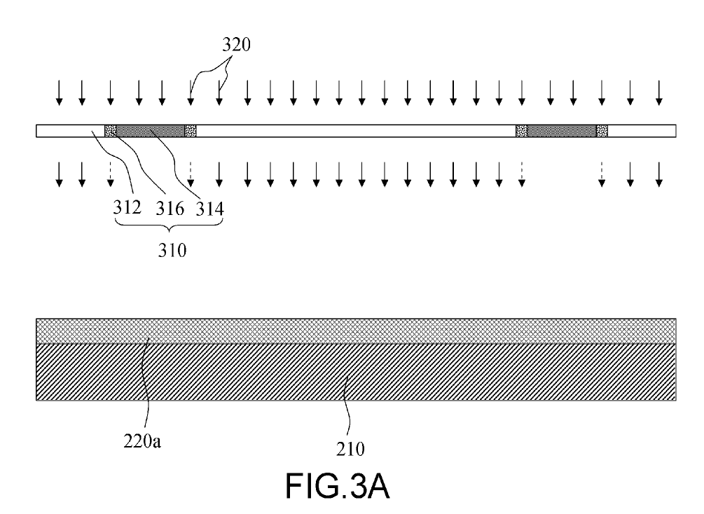

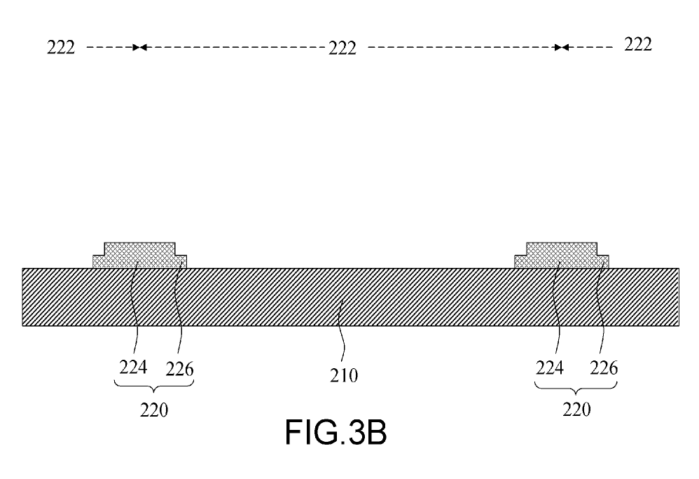

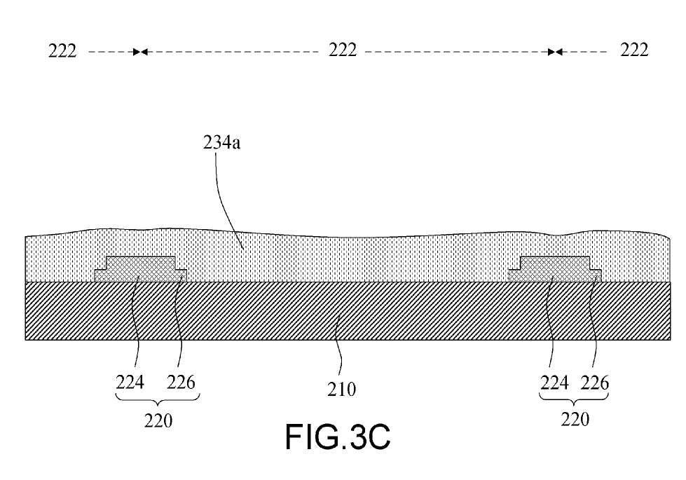

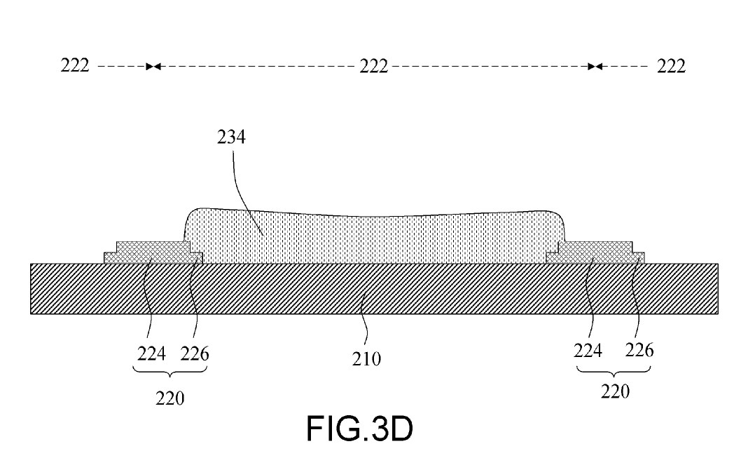

FIG. 3A to FIG. 3D are cross-sectional views showing the process of forming the color filter of the present invention. Referring to FIG. 3A, first, a substrate 210 is provided and a photosensitive layer 220a is formed on the substrate 210; wherein, the photosensitive layer 220a can be a photoresist layer and the pattern defined an exposure and development process has the shading effect. Next, a gray mask 310 is disposed above the substrate 210, wherein, the gray mask 310 has a transparent area 312, a nontransparent area 314 and a semitransparent area 316. When performing an exposure process to the photosensitive layer, a light source 320 can fully penetrate the transparent area 312 to irradiate the photosensitive layer 220a right under the transparent area 312, but the light source can not penetrate the nontransparent area 314 to irradiate the photosensitive layer 220a right under the nontransparent area 314. Besides, the light source 320 can only go through part of the semitransparent area 316 so that only part of the light source 320 can irradiate the photosensitive layer 220a right under the semitransparent area 316.

Referring to FIG. 3B again, in next step, a development process is performed to pattern the photosensitive layer 220a so as to form a black matrix 220 as mentioned before. The black matrix 220 defines a plurality of sub-pixels 222 on the substrate 210 and in each sub-pixel, the height of the black matrix 220 gradually decreases from the periphery of the sub-pixel 222 to the inside of the sub-pixel 222; that is, the height of the inner area 224 of the black matrix 220 is more than the height of the edge area 226 of the black matrix 220.

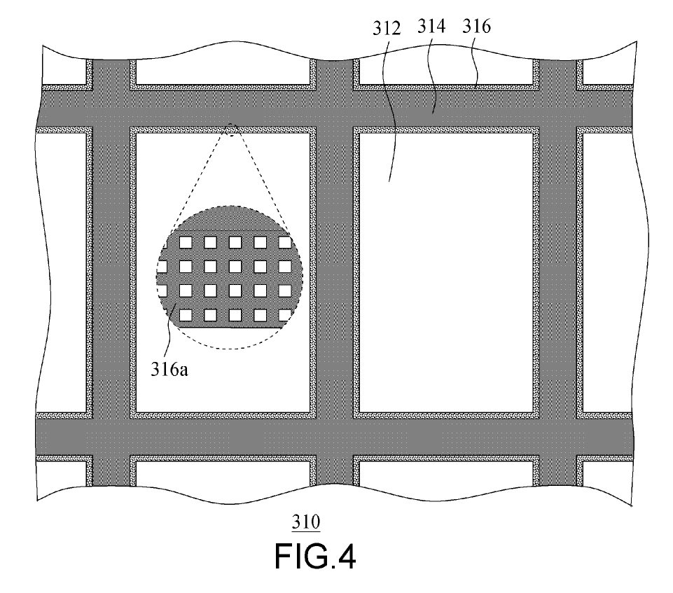

FIG. 4 is a schematic drawing of parts of the gray mask according to an embodiment of the present invention. Referring to FIG. 4, in the present embodiment, the gray mask 310 can be a halftone mask whose nontransparent area 314 can be a quartz substrate on which a shading material such as chrome is plated, and whose transparent area 312 has no shading material plated. Besides, the semitransparent area 316 can consist of a plurality of clear meshes 316a, wherein, the size grading of the clear meshes must be lower than the smallest exposure line width that can be recognized. Generally, the transparent degree of the semitransparent area 316 can be decided by the density or size of the clear meshes 316a. The higher density and the bigger size of the clear meshes 316a are, the higher transparent degree of the semitransparent area 316a is.

In the present embodiment, the semitransparent area 316 consists of the clear meshes 316a with same density and size, therefore, the formed black matrix 220 has two levels of height and gradually decreases in two steps. Naturally, if the semitransparent area 316 further has two clear meshes 316a with different densities, the black matrix with three heights can be formed and gradually decreases in three steps. Accordingly, the higher the gray degree of the semitransparent area 316 is, the more kinds of black matrixes can be formed, and the smaller the height difference between layers is. Those skilled in this art can deduce the structure of the above, so illustrations are omitted here.

Note that the present invention does not limit the kind of gray mask 310 to form the black matrix 320 of the present invention. For example, the gray mask 310 can be a thin layer coating mask or a glass gray mask, wherein the latter can be fabricated in a high energy beam sensitive, HEBS or a laser direct write, LDW process.

Referring to FIG. 3B, up to now the manufacturing of the black matrix 220 has finished. Next, a plurality of colored patterns 230 (as shown in FIG. 2B) are formed in the sub-pixel 222, and then, the manufacturing of the color filter of the present invention is finished. Generally, the colored patterns can be fabricated in a pigment dispersing method, a printing method or a color inkjet method, wherein, the pigment dispersing method is the mainstream manufacturing method. In the following, the pigment dispersing method is described in detail with accompanying drawings.

Referring to FIG. 3C, in the next step, a photoresist layer 234a is formed on the substrate 210 and the black matrix 220, and the photoresist layer 234a includes, for example, the green pigment. Referring to FIG. 3D, then, the process of exposure and development is performed to the photoresist layer 234a in order to define the aforementioned green colored pattern 234. Because in the overlapping area of the black matrix 220 and the green colored pattern 234 the height of the black matrix 220 gradually decreases, so that the height difference of the black matrix 220 is not obvious, and the planar green colored pattern 234 can be formed. By repeating the process shown in FIG. 3C and FIG. 3D, the photoresist layers containing red pigment and blue pigment are respectively formed to define the red colored pattern 232 (shown in FIG. 2B) and the blue colored pattern 236 (shown in FIG. 2B). At this point, the color filter 200 as shown in FIG. 2B has been finished. Note that the present invention does not limit the sequence of forming the aforementioned colored patterns, and does not limit the quantity and colors of the colored patterns either.

Besides, the colored patterns fabricating method in the printing process has the following steps: rolling on an ink in a particular area on the lithograph blanket, then transferring the ink to the sub-pixels so as to form the colored patterns. In addition, the colored patterns fabricating method in the color inkjet process has the following steps: spraying the pigment directly to the sub-pixels with a pressure nozzle, then baking the pigment so as to form the colored patterns. Naturally, there are still other methods of forming the colored patterns, such as the dyeing method and the electro-deposition method, not to be explained here. Note that in the present invention, an electrode layer (not illustrated) or a protection layer (not illustrated) can further be formed on the black matrix and the colored patterns, wherein, the material of the electrode layer can be indium tin oxide (ITO).

In summary, the manufacturing method of the color filter of the present invention has at least following advantages:

1. Because the height of the black matrix gradually decreases, the height difference between layers is relatively small, so that the planar colored patterns can be formed, which helps the subsequent assembly process. Especially, when the color filter and the matrix substrate are assembled in an one drop filling method, the liquid crystal drops would be unlikely to leave traces due to the planar surface of the color filter.

2. The overall height of the black matrix need not be reduced in the present invention, so that the black matrix still maintains the shading effect. Besides, in the present invention, it is not necessary to reduce the overlapping area of the colored pattern and the black matrix, so that color mixing can be decreased.

3. In the present invention, instead of the general mask, the gray mask is used to form the height decreasing characteristic in the black matrix, so that an additional mask is not needed and the manufacturing flow need not be changed, either.

The present invention is disclosed above with its preferred embodiments. It is to be understood that the preferred embodiment of present invention is not to be taken in a limiting sense. It will be apparent to those skilled in the art that various modifications and variations can be made to the structure of the present invention without departing from the scope or spirit of the invention. The protection scope of the present invention is in accordant with the scope of the following claims and their equivalents.

What is claimed is:

1. A color filter, comprising:
a substrate;
a black matrix, disposed on the substrate and defining a plurality of sub-pixels, wherein, in each sub-pixel, the height of the black matrix decreases from the periphery of the sub-pixel to the inside of the sub-pixel; and
a plurality of colored patterns disposed in the sub-pixels respectively.

2. The color filter as claimed in claim 1, wherein the substrate comprises a transparent substrate.

3. The color filter as claimed in claim 1, wherein the material of the black matrix comprises black resin.

4. The color filter as claimed in claim 1, wherein the colored patterns comprise a plurality of red colored patterns, a plurality of green colored patterns and a plurality of blue colored patterns.

5. The color filter as claimed in claim 1, further comprising an electrode layer overlaying the black matrix and the colored patterns.

6. The color filter as claimed in claim 5, wherein the material of the electrode layer comprises indium tin oxide.

7. A manufacturing method of a color filter, comprising:
providing a substrate;
forming a photosensitive layer on the substrate;
disposing a gray mask above the substrate to perform an exposure process to the photosensitive layer, wherein the gray mask has a transparent area, a non-transparent area and at least a semitransparent area;
performing a development process to pattern the photosensitive layer so as to form a black matrix defining a plurality of sub-pixels on the substrate, wherein in each sub-pixel, the height of the black matrix gradually decreases from the periphery of the sub-pixel to the inside of the sub-pixel; and
forming a plurality of colored patterns in the sub-pixels.

8. The manufacturing method of the color filter as claimed in claim 7, wherein the substrate comprises a transparent substrate.

9. The manufacturing method of the color filter as claimed in claim 7, wherein the material of the shading layer comprises black resin.

10. The manufacturing method of the color filter as claimed in claim 7, wherein the colored patterns comprise a plurality of red colored patterns, a plurality of green colored patterns and a plurality of blue colored patterns.

11. The manufacturing method of the color filter as claimed in claim 7, wherein after forming the colored pattern, the method further comprises forming an electrode layer overlaying the black matrix and the colored patterns.

12. The manufacturing method of the color filter as claimed in claim 11, wherein the material of the electrode layer comprises indium tin oxide.

13. The manufacturing method of the color filter as claimed in claim 7, wherein the gray mask is a halftone mask.

14. The manufacturing method of the color filter as claimed in claim 7, wherein, the gray mask comprises a plurality of clear meshes in the semitransparent area.

15. The manufacturing method of the color filter as claimed in claim 7, wherein the colored patterns are fabricated in a pigment dispersing method.

16. The manufacturing method of the color filter as claimed in claim 7, wherein, the colored patterns are fabricated in a printing method.

17. The manufacturing method of the color filter as claimed in claim 7, wherein, the colored patterns are fabricated in a color inkjet method.
